(19) United States
(12) Patent Application Publication
(10) Pub. No.: US 2026/0281903 A1
(43) Pub. Date: Sep. 17, 2026

(54) FIELD DEVICE FOR A MESH NETWORK AND METHOD FOR OPERATING SAME

(71) Applicant: ifm electronic gmbh, Essen (DE)

(72) Inventor: Thomas Krone, Fronreute (DE)

(73) Assignee: ifm electronic gmbh, Essen (DE)

(21) Appl. No.: 19/566,371

(22) Filed: Mar. 13, 2026

(30) Foreign Application Priority Data
Mar. 14, 2025 (DE) 102025109824.7

(51) Int. Cl. H04W 52/02; H04W 84/18

(52) U.S. Cl. CPC H04W 52/0235; H04W 84/18

(57) ABSTRACT

A field device for a mesh network includes a control circuit and a wake-up circuit connected to a wireless communication interface for receiving a wake-up signal, the field device including a first operating mode and a second operating mode, the control circuit having reduced energy consumption or is deactivated in the first operating mode, and the control circuit being configured to send and receive data in the second operating mode. The wake-up circuit comprises includes an amplifier circuit. The amplifier circuit can be activated depending on a wake-up criterion and the wake-up circuit configured to amplify a received wake-up signal using the amplifier circuit and to switch the control circuit from the first operating mode to the second operating mode depending on the wake-up radio signal.

### CROSS-REFERENCE TO RELATED PATENT APPLICATION

This application claims the benefit of and priority to German Patent Application number 102025109824.7 filed Mar. 14, 2025, which is incorporated herein by reference in its entirety.

### FIELD OF THE DISCLOSURE

The invention relates to a field device and a method for operating a field device in a meshed network, for example for a storage/racking system, such as a pick-by-light system.

### BACKGROUND OF THE DISCLOSURE

Battery-powered field devices that are integrated into a mesh network by means of a wireless communication interface have, on the one hand, the problem that they are in a sleep mode for extended periods of time in order to minimize energy consumption. However, communication with the field device in sleep mode is not possible.

On the other hand, field devices require a great deal of energy in continuous reception mode. For this reason, meshed networks were developed in the past in which the field devices are not permanently in reception mode but only briefly at certain time intervals. The device chains awake cyclically in a time-synchronized manner in order to then transmit the data from one field device to the next field device. However, they also awake even when no data need to be exchanged, which consumes energy unnecessarily.

Since in most cases the purpose of field devices designed as sensor nodes and actuator nodes is to transmit data to the base station/gateway/main node, these mesh-network protocols are usually optimized to minimize uplink latency.

There are usually no routing tables, firstly for minimizing the amount of data to be transmitted which is necessary only for network configuration, and secondly for keeping the algorithms as simple as possible so as to reduce the computing power in the individual units. This saves further energy. For this reason, usually only the neighboring node that is the best path towards the main node is stored internally. The best path is usually defined as the path with the lowest susceptibility to interference while having the smallest number of hops.

To further reduce the latency in the uplink, the wake-up moments of the individual field devices are time-shifted minimally such that an uplink packet is passed through as directly as possible. However, this hinders the downlink packets, because in the opposite direction of transmission it is of course always necessary to wait for the next synchronization time before the data can be transmitted to the next field device.

Furthermore, since there are no routing tables, downlink packets are forwarded via broadcast message, or via flooding, through all field devices until the correct field device happens to receive the packet. With a simple chain, this might still be reasonably efficient. However, as soon as there is a network, these packets will also be sent to other field devices/network nodes that are significantly further away, simply because the incorrect field device cannot directly detect when a packet has correctly arrived at the correct field device.

### SUMMARY OF THE DISCLOSURE

The object of the invention is to provide a field device for a mesh network, as well as a method for operating same, wherein the field device has low energy consumption and can be addressed by radio signals with a low signal strength.

The object is achieved by a field device according to claim 1 and a method according to claim 9. Advantageous embodiments of the invention are specified in the dependent claims.

Advantageously, a field device for a mesh network is specified, the field device comprising a control circuit and a wake-up circuit which is connected to a wireless communication interface for receiving a wake-up signal, wherein the field device comprises a first operating mode and a second operating mode, wherein in the first operating mode the control circuit has reduced energy consumption or is deactivated and wherein in the second operating mode the control circuit is designed and configured to send and receive data. The wake-up circuit comprises an amplifier circuit, wherein the amplifier circuit can be activated depending on a wake-up criterion, and wherein the wake-up circuit is designed to amplify a received wake-up signal by means of the amplifier circuit and to switch the control circuit from the first operating mode to the second operating mode depending on the wake-up radio signal.

This means that a field device with low energy consumption and low latency can be provided, which can also be addressed by means of a low-strength radio signal designed as a wake-up signal. By analysis of this received radio signal, the signal can be recognized by the field device as a wake-up signal, and a receiver sensitivity of up to −90 dBm can be achieved by means of the amplifier circuit. Compared to conventional wake-up receivers, this can increase the range by a factor of 30. A successfully received wake-up signal can be acknowledged by means of an acknowledgment response. This can, for example, reduce the transmission error rate.

The field device can be in particular a sensor node, an actuator node, or a network adapter for a sensor node or actuator node. For example, the field device is a sensor of a pick-by-light system, a racking system, or another storage system. In some applications, the field device can also be a sensor-actuator node of a process automation system or of an industrial production plant.

Preferably, the amplifier circuit is designed as a transistor amplifier circuit. In particular, the amplifier circuit can be configured to amplify an incoming modulated wake-up signal, as well as to output an amplified and modulated wake-up signal. This has the advantage that the amplified wake-up signal remains modulated, so that information carried in the incoming wake-up signal is still present even after amplification. In particular, the addressing of a field device can thus be retained and the probability of waking up the wrong field device minimized. For example, the modulation can be preserved by using an amplitude-shift keying method, such as on-off keying, and be used to address the field device.

In some configurations, the wireless communication interface is used not only for receiving the wake-up signal in the first operating mode but also for data exchange in the second operating mode. In alternative configurations, a second wireless communication interface can be provided. This second interface can then be in a deactivated state in the first operating mode and activated when switching to the second operating mode takes place. The field device can then exchange data in the second operating mode via the second wireless communication interface. The second wireless communication interface is advantageously also coupled to the amplifier circuit so that received signals can be amplified.

The amplifier circuit can be repeatedly activated for a period of time tₐₘₚ (activation phase), wherein successive activation phases have a time interval tₚₐᵤₛₑ between them. The wake-up criterion can in particular comprise a time, a time interval, a duration, a sensor or actuator signal, an environmental parameter, and/or an external sensor signal. Preferably, the wake-up criterion comprises at least one variable time duration.

The time duration tₐₘₚ for which the amplifier circuit is activated in each case can vary. Likewise, the time interval tₚₐᵤₛₑ can be variable. In some embodiments, the time duration tₐₘₚ and/or the time interval tₚₐᵤₛₑ is selected from a set of time durations Mtₐₘₚ or from a set of time intervals Mtₚₐᵤₛₑ. The time duration tₐₘₚ and/or the time interval tₚₐᵤₛₑ can in particular be selected randomly or pseudo-randomly from the sets Mtₐₘₚ and Mtₚₐᵤₛₑ.

Due to the variable design of the time interval tₚₐᵤₛₑ and/or the duration tₐₘₚ, the probability of receiving a wake-up signal during an activation phase can be increased. In particular, a period duration T_{WA} of a transmission interval of the wake-up signal can be prevented from coinciding with a period duration Tₐₘₚ Of the activation phase of the amplifier circuit over a longer period of time.

The field device can in particular comprise a non-volatile data storage device in which is stored the set of time durations Mtₐₘₚ and/or the set of time intervals Mtₚₐᵤₛₑ, or a corresponding calculation rule.

Furthermore, a wake-up signal can be sent repeatedly, for example by a central unit or another field device. In particular, N wake-up signals can be sent with a defined time interval t_delay between them. The time interval t_delay can also be selected to be variable. For example, a table of possible time intervals t_delay or a corresponding calculation rule can be stored in the data memory. After a definable number of repetitions, sending of the wake-up signals can be aborted and a message can be sent from the field device back to the base station/gateway/main node. An error can thus be detected quickly.

Furthermore, each field device can be assigned a field device ID, a network ID and/or a group ID. These identifiers can be used to wake up the corresponding field devices or the field devices of a network and/or the field devices of a field device group. Furthermore, such an abstraction allows a better allocation of field devices.

In some embodiments, the field device can be designed to detect the center frequency of a carrier burst of the wake-up signal. It can thus be provided that the field device or a group of field devices in the mesh network can be addressed via the center frequency. The field device or different groups of field devices can thus each be assigned to a center frequency. A received wake-up signal can then be validated by analyzing the center frequency. After successful validation, the field devices in question can be switched from the first operating mode to the second operating mode.

Preferably, the field device comprises an energy source for supplying the field device, which energy source can in particular comprise a battery and/or an energy harvesting device. The energy harvesting device can, for example, comprise a photovoltaic module, a piezoelectric energy harvester, an electromechanical energy harvester, and/or a thermoelectric energy harvester (in particular based on the Peltier/Thomson and/or Seebeck effect). Due to the low energy consumption of the wake-up circuit, the field device can be operated with low energy consumption overall, thus making energy-autonomous operation possible (e.g. by means of one of the aforementioned energy harvesting devices).

Furthermore, a method for operating a field device having a wake-up circuit comprising an amplifier circuit and with a wireless communication interface is specified, wherein the method comprises the following steps:
operating the field device in a first operating mode with reduced power consumption, comprising intermittently activating the amplifier circuit depending on a wake-up criterion and receiving a radio signal via the wireless communication interface, wherein the radio signal is amplified by the amplifier circuit and analyzed by the wake-up circuit;
switching to a second operating mode when the radio signal has been recognized as a wake-up signal; and
operating the field device in the second operating mode to send and receive data by means of the wireless communication interface or by means of a second wireless communication interface.

The amplification of the received radio signals also makes it possible to detect wake-up signals with a low signal strength and to keep the energy consumption of the field device low. Preferably, the method comprises the sending of an acknowledgment message by the field device to another unit, in particular to a central unit or to another field device, when a (valid) wake-up signal has been received.

The wake-up signal can comprise a carrier burst at a specified frequency. In some embodiments, the method comprises detecting a center frequency of a carrier burst, this frequency being assigned to a field device or a group of field devices in the network.

The wake-up signal can comprise the field device ID, which is advantageously sent after the carrier burst. The field device ID is assigned to the field device in the network for which the message is intended. Advantageously, the method then comprises the recognition of the field device ID.

The wake-up signal can also comprise a group ID, wherein the receiver group ID is assigned to a node group of the network for which the message is intended. The sending of the receiver group ID can then advantageously be provided. The method is particularly advantageous because it comprises the recognition of the group ID.

In another aspect, the wake-up signal can comprise the network ID. The method can therefore comprise a step for receiving and analyzing the network ID.

Following the transmission of the field device ID, group ID and/or network ID, the wake-up signal can also comprise payload data. Preferably, the method comprises receiving and analyzing payload data in the wake-up signal.

Furthermore, it can be provided that the wake-up signal comprises a sender ID that is assigned to a node of the network from which the message was sent or forwarded to the addressed field device. The method preferably comprises the receiving and analyzing of the sender ID by the field device.

Furthermore, the wake-up signal can comprise a sender group ID which is assigned to a field device group from which the message addressed to the field device was sent or forwarded. The method can correspondingly comprise the receiving and analyzing of the sender group ID.

The wake-up signal can also comprise an origin ID, wherein the origin ID is assigned to the network participant (e.g. a field device or a central unit) from which the wake-up signal was originally sent. Correspondingly, the method can comprise the receiving and analyzing of the origin ID.

Furthermore, the wake-up signal can comprise a network origin ID, which is assigned to the network from which the wake-up signal was originally sent.

The wake-up signal can also contain a counter value Nₕₒₚ, wherein Nₕₒₚ specifies the number of hops within the mesh network. When forwarding a wake-up signal, the counter value Nₕₒₚ. can be incremented by one by the sending network participant (such as a field device).

In some developments, the method comprises the sending or forwarding of a wake-up signal by the field device, wherein the field device adds at least one of the following identifiers/IDs to the wake-up signal: the field device ID, the group ID, the network ID, the sender ID, the sender group ID, the origin ID, the network origin ID, the counter value Nₕₒₚ. The method can also comprise a step for sending an acknowledgment message by the field device.

The invention is explained in more detail below with the aid of exemplary embodiments while making reference to the drawings.

### BRIEF DESCRIPTION OF THE DRAWING FIGURES

In the drawings, shown schematically:

FIG. 1 shows a mesh network with a plurality of field devices;

FIG. 2a shows an exemplary embodiment of a field device with a wake-up circuit comprising an amplifier circuit;

FIG. 2b shows a further exemplary embodiment of a field device with a wake-up circuit comprising an amplifier circuit;

FIG. 3 shows an example of a wake-up signal and an amplifier signal;

FIG. 4 shows an exemplary embodiment of a wake-up circuit with an amplifier circuit;

FIG. 5 shows a wake-up signal according to an example;

FIG. 6 shows an example of a grouping of field devices in a mesh network; and

FIG. 7 shows an embodiment of a method for operating a field device according to an example.

### DETAILED DESCRIPTION OF CERTAIN EMBODIMENTS OF THE DISCLOSURE

In the following description of the preferred embodiments, the same reference signs denote the same or comparable components.

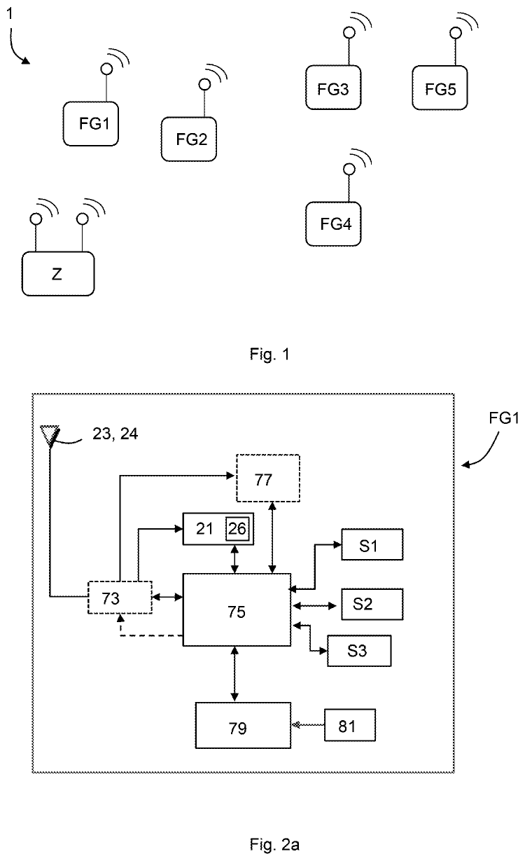

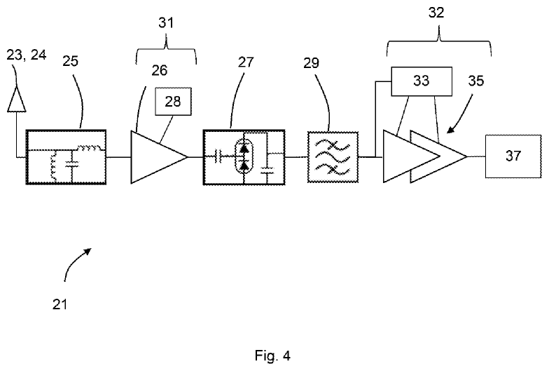

FIG. 1 shows by way of example a plurality of field devices FG1 to FG5, as well as a central unit Z in a mesh network 1. The central unit Z can be for example a gateway or a base station. The mesh network can be for example part of a pick-by-light system in an industrial production environment, an automation plant, or a warehouse. The field devices FG1 to FG5 can comprise for example network nodes or optical, capacitive or inductive sensors, which monitor for example a fill level or the stock of goods or other objects. The design of the network as a mesh network 1 makes it possible to exchange radio signals between the central unit Z and the field devices FG1 to FG5, as well as between the field devices FG1 to FG5 themselves, even if they cannot communicate directly with each other due to range limitations. The field devices FG1 to FG5 can thus forward messages to the respective other field devices FG1 to FG5 or to the central unit Z. To keep the energy consumption of the field devices FG1 to FG5 low, they can be operated in a first operating mode BM1 with reduced energy consumption. In particular, it can be advantageous here to deactivate circuit components such as control circuits or communication interfaces in the first operating mode BM1 or to operate them with reduced functionality. By means of a wake-up signal, the field devices FG1 to FG5 can each be put into a second operating mode BM2, which can be in particular a normal operating mode. To increase the range, the field devices FG1 to FG5 have a wake-up circuit 21 with an amplifier circuit 31 (see FIG. 4). The amplifier circuit 31 can amplify radio signals, such as wake-up signals, arriving at the corresponding field device FG1 to FG5, so that these signals can be demodulated and analyzed.

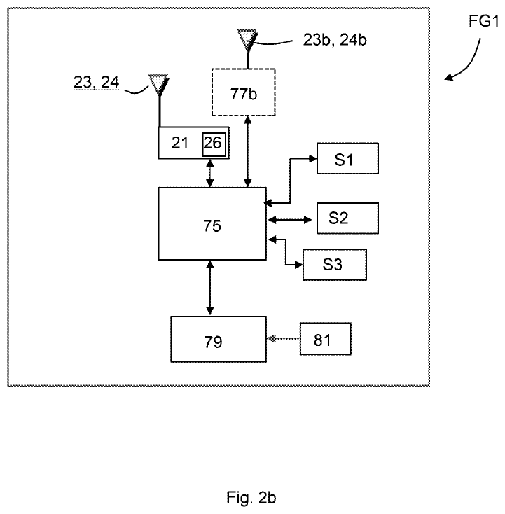

FIG. 2a schematically shows an exemplary embodiment of the field device FG1 with the wake-up circuit 21. The wake-up circuit 21 comprises in particular the amplifier circuit 31. In order to be able to detect even comparatively weak wake-up signals 91, the amplifier circuit 31 is intermittently activated according to one or more criteria (activation phase).

The field device FG1 also comprises a control circuit 75, for example a microcontroller, as well as a first sensor S1 and two further sensors S2 and S3 which are connected to the control circuit 75. A DC-DC converter 79 is provided for the power supply. A wake-up signal can be received by means of a wireless communication interface 23 and, if necessary, further data can also be exchanged. The wireless communication interface 23 comprises an antenna 24, which can be connected via an RF switch 73 on the one hand to the wake-up circuit 21 and on the other hand directly to the control circuit 75. If the field device FG1 is operated in the first operating mode BM1, the control circuit 75 is in a deactivated state or its power consumption is reduced. In particular, the wireless communication interface 23 can be operated in an energy-saving mode with reduced energy consumption, or at least intermittently purely passively. The RF switch 73 is configured in the first operating mode BM1 such that signals received via the wireless communication interface 23 are transmitted to the wake-up circuit 21. If a received signal is identified as a wake-up signal, the control circuit 75 can switch to the second operating mode BM2 (e.g. a normal operating mode). In particular, a main radio protocol 77 can be activated when doing this. By means of the RF switch 73, the wireless communication interface 23 can be connected to, or operated with, a main radio protocol 77. The main radio protocol 77 can comprise appropriate transceiver components for communication with a radio standard/radio protocol such as WLAN/IEEE 802.11, Wi-Fi, Bluetooth, Bluetooth Low Energy, LPWAN (e.g. mioty or LoRa/-WAN), or ZigBee.

In particular, the wireless communication interface 23 can be fully activated in the second operating mode BM2, so that data can be sent and received with, for example, a higher bandwidth and/or a lower latency.

A further exemplary embodiment of the field device FG1 is shown schematically in FIG. 2b. In contrast to FIG. 2a, a second wireless communication interface 23b is provided here which is used for data exchange in the second operating mode BM2. A corresponding main radio protocol 77b can then be used for communication via the second wireless communication interface 23b. The second wireless communication interface 23b can use a different carrier frequency than the wake-up signal, and a separate second antenna 24b. In this embodiment, the RF switch 73 shown in FIG. 2a can be omitted.

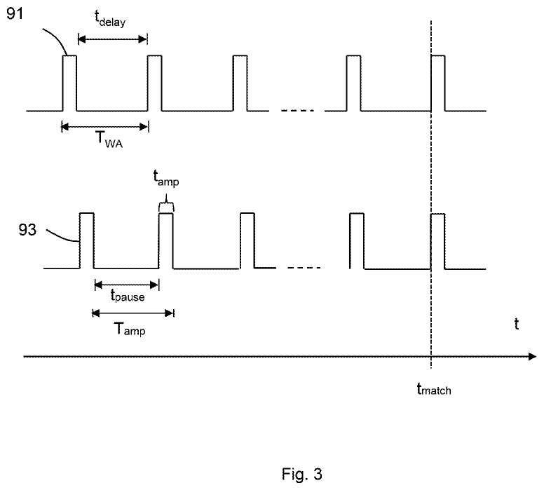

FIG. 3 schematically shows a radio signal/wake-up signal 91 received at the wireless communication interface 23, which signal is amplified and made available to the wake-up receiver 37 (see FIG. 4). A schematic representation of an amplifier signal 93 of the amplifier circuit 31 is also shown. A high level of the amplifier signal 93 indicates activation times of the amplifier circuit 31, while a low level indicates deactivation times of the amplifier circuit 31.

The amplifier circuit 31 can be repeatedly activated for a time span t_amp. During the time span t_amp, a received wake-up signal 91 can be amplified and thus detected particularly well. The time span t pause between two activation phases, as well as the time span t_amp, can be chosen to be constant or variable. The time spans t_amp and/or t_pause can also be kept constant for a number n_pause of activation phases and then varied. For example, the time spans t_amp and/or t_pause can be selected randomly or pseudo-randomly from a set of time intervals, e.g. from a corresponding list. By choosing a variable time span t_pause and/or a variable time span t_amp, it is in particular possible to ensure over a longer period of time that wake-up signals 91 are not sent with a time offset to the activation phases. This minimizes delays in message transmission. Furthermore, the wake-up signal 91 sent by a unit such as the central unit Z or another field device can be repeatedly transmitted. For example, N wake-up signals 91 can be sent if no response from the addressed field device is received by the sending unit. The wake-up signals 91 can be sent with a time interval t_delay between them, wherein t_delay can be chosen to be variable.

In the example, not only the wake-up signal 91 but also the amplifier signal 93 have constant period durations, wherein a period duration Tₐₘₚ of the amplifier signal 93 is slightly shorter than a period duration T_{WA} of the wake-up signal 91. Due to the similar period durations Tₐₘₚ and T_{WA}, the two signals overlap temporally only after a relatively long time (at t=t_{match}). In the example shown, the wake-up signal 91 is therefore received with a comparatively large delay, which is disadvantageous. To ensure that the wake-up signal 91 is quickly received by the relevant field device FG1 to FG6, and/or that messages within the mesh network 1 are quickly forwarded, advantageously at least one of the times t_pause, t_amp and t_delay is variable. This can prevent in particular the disadvantageous delay in receiving the radio signals, such as the wake-up signal 91.

FIG. 4 schematically shows an exemplary embodiment of the wake-up circuit 21 with the amplifier circuit 31. The wake-up circuit 21 also comprises the wireless communication interface 23 with the antenna 24. The wireless communication interface 23 is connected to a matching network (MN) 25. By means of the MN 25, a frequency-dependent impedance of the antenna 24 can be matched to an impedance of a load coupled to the antenna 24. In this way the output impedance of the antenna 24 is matched to the input impedance of the load given by subsequent circuit components. The MN 25 is advantageously designed as a lossless matching network (LMN), wherein this network comprises only reactive components such as capacitors and inductors. As a result, the energy transfer of the received signal to the downstream circuit components, in particular to an evaluation circuit, can be maximized.

In the example, the MN 25 is connected to the amplifier circuit 31, which comprises an amplifier 26 designed as a radio-frequency (RF) amplifier, as well as a trigger circuit 28 for controlling the amplifier 26. The trigger circuit 28 determines when the amplifier 26 is switched on or off. In the example, the amplifier 26 is connected to an envelope detector circuit 27 which comprises an LC filter 29. An output of the envelope detector circuit 27 is connected to an intermediate frequency (IF) amplifier circuit 32, which comprises a logic circuit 33 and at least one IF amplifier 35. The logic circuit 33 is in turn connected to a control input of the at least one IF amplifier 35. An output of the IF amplifier circuit 32 is connected to a wake-up receiver 37. Finally, the received and amplified wake-up signals 91 can be detected by means of the wake-up receiver 37 and the respective field device FG1 to FG5 can be controlled to switch to the second operating mode BM2.

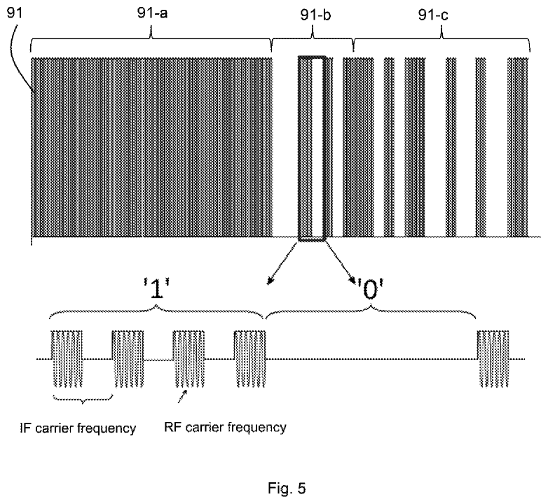

FIG. 5 shows the wake-up signal 91 as an example of a signal modulated in an amplitude shift keying method. The amplitude shift keying method is implemented here as on-off keying (OOK method), wherein an RF carrier signal is switched on and off, so that a high value “1” or a low value “0” is transmitted. The OOK method has the advantage that it allows a simple demodulation of the radio signals with low energy consumption. The packet structure of the wake-up signal 91 comprises, for example, an 18 kHz carrier burst 91-a, a wake-up header 91-b, and a wake-up message 91-c. In this example, the wake-up header is modulated with an intermediate frequency (IF) carrier frequency likewise of 18 kHz, as well as with a radio-frequency RF carrier frequency of, for example, 868 MHz. In this example, the wake-up header comprises 8 bits. A radio signal can be identified as wake-up signal 91 by means of the wake-up header. The subsequent wake-up message 91-c comprises for example 16 bits, and can comprise in particular an identification number of the addressed field device FG1 and, if applicable, further data.

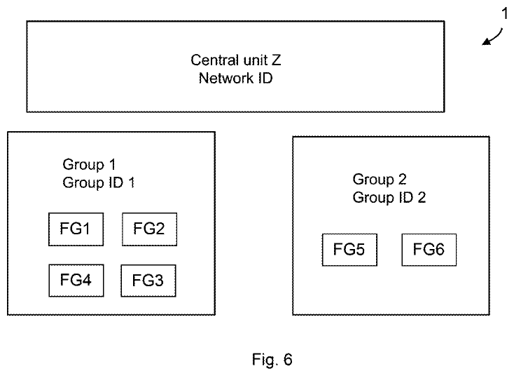

As schematically illustrated in FIG. 6, the field devices FG1 to FG6 can advantageously be combined into field device groups 91. In a first field device group G1 with the group ID “1” a total of four field devices FG1 to FG4 are grouped together. In a second field device group G2 with a group ID “2” two field devices FG5 and FG6 are grouped together. The field devices FG1 to FG6, as well as the central unit Z (for example a base station or a gateway) are networked in a mesh network 1. A network ID is assigned to the mesh network 1. The units of the mesh network 1 can be addressed via the network ID. This can be advantageous in particular for communication with higher-level units, neighboring networks, or for configuring the field devices FG1 to FG6 and the central unit Z.

The group membership can be stored in the corresponding field devices FG1 to FG6 and in the central unit Z. A wake-up signal can then be directed to one or more field device groups G1, G2, so that these can be woken up in a targeted manner. For example, the wake-up signal 91 can comprise the group ID and/or the network ID, which can be encoded for example in the wake-up message 91-c of the OOK signal shown in FIG. 5.

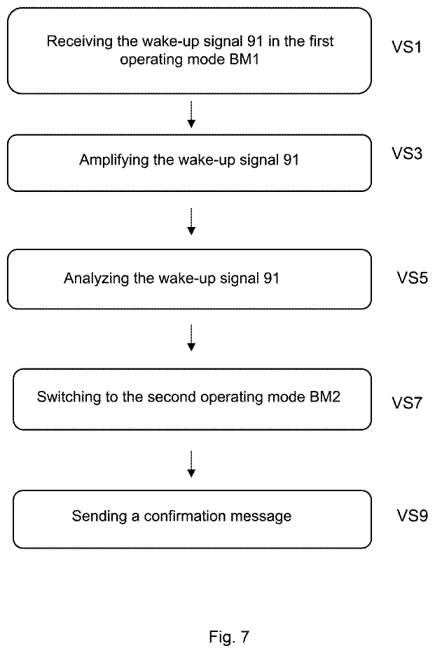

A flowchart of an exemplary embodiment of a method according to the invention is shown schematically in FIG. 7. A field device FG1, . . . , FG6 integrated into the mesh network 1 can be in the first operating mode BM1 with reduced energy consumption. For example, in a first method step VS1 a wake-up signal 91 can then be received by the field device FG1. The wake-up signal 91 is amplified in a step VS3 by means of the amplifier circuit 31. The wake-up signal 91 is then analyzed in a step VS5. In particular, the wake-up signal 91 can be validated here. To validate the wake-up signal 91, it can be checked whether the received wake-up signal 91 has a previously specified structure. Furthermore, it can be checked whether the wake-up signal 91 is intended for the field device FG1, for example by comparing a field device ID, a group ID, and/or a network ID with a corresponding ID transmitted in the wake-up signal 91. If a valid wake-up signal 91 is detected, the field device FG1 is switched to the second operating mode BM2 in a step VS7. The second operating mode BM2 can be in particular a normal operating mode. For example, the control circuit 75, the main radio protocol 77, or the main radio protocol 77b and the second wireless communication interface 77b can be activated here. Likewise, here the amplifier circuit 31 can be activated and communication can be carried out by means of the main radio protocol 77 (or 77b). Finally, in an optional step VS9 the field device FG1 can send an acknowledgment message.

### LIST OF REFERENCE SIGNS

1 Mesh network
21 Wake-up circuit
23 Wireless communication interface
23b Second wireless communication interface
24 Antenna
24b Second antenna
25 Matching network
26 Amplifier
27 Envelope detector circuit
28 Trigger circuit
29 LC filter
31 Amplifier circuit
32 IF amplifier circuit
33 IF logic circuit
35 IF amplifier
37 Wake-up receiver
73 RF switch
75 Control circuit
77 Main radio protocol
77b Main radio protocol
79 DC-DC converter
81 Battery
91 Wake-up signal
91-a Carrier burst
91-b Wake-up header
91-c Wake-up message
93 Amplifier signal
BM1 First operating mode
BM2 Second operating mode
G1, G2 Field device group
FG1 to FG6 Field device
S1, S2, S3 Sensor
Z Central unit

1. A field device (FG1, . . . , FG6) for a mesh network, the field device (FG1, . . . , FG6) comprising a control circuit (75) and a wake-up circuit (21) which is connected to a wireless communication interface (23) for receiving a wake-up signal (91), wherein the field device (FG1, . . . , FG6) comprises a first operating mode (BM1) and a second operating mode (BM2), wherein the control circuit (75) has reduced energy consumption or is in a deactivated state in the first operating mode (BM1) and wherein the control circuit (75) is designed and configured to send and receive data in the second operating mode (BM2), characterized in that the wake-up circuit (21) comprises an amplifier circuit (31), wherein the amplifier circuit (31) can be activated depending on a wake-up criterion and wherein the wake-up circuit (21) is configured to amplify a received wake-up signal (91) by means of the amplifier circuit (31) in order to amplify and to switch the control circuit (75) from the first operating mode (BM1) to the second operating mode (BM2) depending on the wake-up radio signal (91).

2. The field device (FG1, . . . , FG6) according to claim 1, characterized in that the control circuit (75) is designed and configured to send and receive data via the wireless communication interface (23) in the second operating mode (BM2).

3. The field device (FG1, . . . , FG6) according to claim 1, wherein the control circuit (75) comprises a second wireless communication interface (23b), characterized in that the control circuit (75) is designed and configured to send and receive data via the second wireless communication interface (23b) in the second operating mode (BM2).

4. The field device (FG1, . . . , FG5) according to claim 1, characterized in that the wake-up criterion comprises a time, a time interval, a duration, a sensor or actuator signal, an environmental parameter, and/or an external sensor signal.

5. The field device (FG1, . . . , FG6) according to claim 4, characterized in that the wake-up criterion comprises at least one variable time span.

6. The field device (FG1, . . . , FG6) according to claim 5, characterized in that the at least one variable time span relates to a time span (t_pause) between two activation phases of the amplifier circuit (31), and/or a time span (t_amp) of the active time of the amplifier circuit (31).

7. The field device (FG1, . . . , FG6) according to claim 1, characterized in that the field device (FG1, . . . , FG6) comprises an energy source for supplying the field device, wherein the energy source comprises a battery (81) and/or an energy harvesting device.

8. The field device (FG1, . . . , FG6) according to claim 1, characterized in that the field device (FG1, . . . , FG6) is configured as a sensor node, actuator node, or as a network adapter for a sensor node or actuator node.

9. The field device (FG1, . . . , FG6) according to claim 1, characterized in that the amplifier circuit (31) is designed as a transistor amplifier circuit which amplifies an incoming modulated wake-up signal (91) and outputs it as an amplified and modulated wake-up signal (91).

10. A method for operating a field device (FG1, . . . , FG6) having a wake-up circuit (21) comprising an amplifier circuit (26) and having a wireless communication interface (23), characterized in that the method comprises the following steps:
operating the field device (FG1, . . . , FG6) in a first operating mode (BM1) with reduced power consumption, comprising intermittently activating the amplifier circuit (21) depending on a wake-up criterion and receiving a radio signal via the wireless communication interface (21), wherein the radio signal is amplified by means of the amplifier circuit (26) and analyzed by the wake-up circuit (21);
switching to a second operating mode (BM2) when the radio signal has been recognized as a wake-up signal (91); and
operating the field device (FG1, . . . , FG6) in the second operating mode (BM2) for sending and receiving data by means of the wireless communication interface (23) or by means of a second wireless communication interface (23b).

11. The method according to claim 10, characterized in that the method comprises the sending of an acknowledgment message by the field device (FG1, . . . , FG5) in response to receiving a wake-up signal (91) addressed to the field device (FG1, . . . , FG6).

12. The method according to claim 10or 11, characterized in that the wake-up signal (91) comprises one or more of the following items of information and wherein this information is received and analyzed by the field device (91):
a field device ID, wherein the field device ID is assigned to the field device (FG1, . . . , FG6) of the mesh network (1) for which the message is intended;
a group ID, wherein the group ID is assigned to a field device group (G1, G2) of the mesh network (1) for which the message is intended;
a network ID, wherein the network ID is assigned to the mesh network (1) to which the field device (FG1, . . . , FG6) is assigned;
a sender ID, wherein the sender ID is assigned to the field device (FG1, . . . , FG6) of the mesh network from which the message was sent or forwarded to the addressed field device (FG1, . . . , FG6);
a sender group ID, wherein the sender group ID is assigned to a field device group (G1, G2) from which the message addressed to the field device (FG1, . . . , FG6) was sent or forwarded;
an origin ID, wherein the origin ID is assigned to the field device (FG1, . . . , FG6) or other network participant from which the wake-up signal (91) was originally sent;
a network origin ID, wherein the network origin ID is assigned to a mesh network (1) or other network from which the wake-up signal (91) was originally sent;
a counter value Nₕₒₚ, where the numerator value Nₕₒₚ indicates the number of hops traversed by the wake-up signal (91).

13. The method according to claim 10,
wherein the field device comprises a control circuit (75) and a wake-up circuit (21) which is connected to a wireless communication interface (23) for receiving a wake-up signal (91), wherein the field device (FG1, . . . , FG6) comprises a first operating mode (BM1) and a second operating mode (BM2), wherein the control circuit (75) has reduced energy consumption or is in a deactivated state in the first operating mode (BM1) and wherein the control circuit (75) is designed and configured to send and receive data in the second operating mode (BM2), characterized in that the wake-up circuit (21) comprises an amplifier circuit (31), wherein the amplifier circuit (31) can be activated depending on a wake-up criterion and wherein the wake-up circuit (21) is configured to amplify a received wake-up signal (91) by means of the amplifier circuit (31) in order to amplify and to switch the control circuit (75) from the first operating mode (BM1) to the second operating mode (BM2) depending on the wake-up radio signal (91).
